(19) United States
(12) Patent Application Publication
(10) Pub. No.: US 2011/0318523 A1
(43) Pub. Date: Dec. 29, 2011

(54) MODULAR ANTI-FATIGUE FLOOR MAT ASSEMBLY

(75) Inventor: Curtis L. Todd, St. Louis, MO (US)

(73) Assignee: Magnet Works, Ltd., St. Louis, MO (US)

(21) Appl. No.: 12/821,419

(22) Filed: Jun. 23, 2010

(51) Int. Cl. B32B 3/08; B32B 3/02

(52) U.S. Cl. 428/67; 428/81

(57) ABSTRACT

Various modular anti-fatigue floor mat assemblies are provided herein. According to one embodiment, the modular floor mat assembly includes at least one of a plurality of generally planar, elongated top mats. The top mats are interchangeable, each mat having substantially the same length and height. The modular floor mat assembly also includes a lower support frame having an elongated body fabricated from a compressible polymer with a durometer measurement of less than approximately 60 Shore C. The support frame body has a recessed cavity that is circumscribed by a round-chamfered border. The top mat is removably attached to the support frame body, disposed within the recessed cavity.

### TECHNICAL FIELD

The present invention relates generally to interior floor mats, and more particularly to interior floor mats that provide anti-fatigue qualities to the user.

### BACKGROUND OF THE INVENTION

Protective floor mats are available in various forms for a myriad of uses. Some floor mats, such as kitchen mats or bath mats, are used to provide a discrete surface upon which to support and separate a person from the underlying floor. The construction of such mats generally provides a more comfortable standing surface and creates a thermal barrier, insulating the user from heat or cold that is emanating from the floor. Kitchen mats and bath mats can also be useful in protecting floor surfaces from contact with liquids and sources of dirt or other contamination. Floor mats can also serve to protect the underlying surface from scratches and damage caused, for example, by a person's shoes.

Another common type of floor mat is the exterior doormat. A doormat, also known as a “welcome mat,” is a flat, usually rectangular mat that is placed proximate to the entrance of a house or other building. The doormat provides a surface for people to wipe or scrub the soles of their shoes or feet to remove water, snow, mud, dirt and/or debris before entering the building. Doormats are usually fabricated as a unitary panel made from very rigid, coarse materials such as coir, palmyra fibers, nylon, fiberboard, or aluminum and other metals.

Multi-layer doormats are also available, some of which include a bulbous upper layer for absorbing moisture and dirt, and a rigid slip-resistant base to which the upper layer is permanently fused or bonded. The base is typically fabricated from a very hard rubber or midgrade rubber with a wire-woven skeleton. In some designs, the base is an amalgamation of granulated rubber that is recycled from the outer tread of old automobile tires, which is known as “crumb rubber,” which is a hard rubber material. The base is often fabricated with channels and drainage holes for collecting and diverting water and debris. Some varieties of doormats may include decorative metal inserts.

In another exterior door mat design, the first component is made of crumb rubber and is formed into a tray-like structure with a central recess and a course decorative outer border around the recess. A user can interchangeably place various decorative thin crumb-rubber mats into the central recess of the tray. Such an exterior door mat design is available from Magnet Works, Ltd. (http://www.magnetworks.com), the owner of the present application.

However, door mats are generally unsuitable for indoor use where bare feet will continuously contact the mat or the user is expected to stand on the mat for long periods of time. In particular, the coarse, rutted upper surface (including, perhaps, decorative metal inserts) of a door mat is generally uncomfortable, and can irritate and ablate the skin on a person's foot. In addition, standing on a dense, hard rubber door mat for a long duration becomes uncomfortable because the static leg muscles must continuously flex in order to keep the body in an upright position, reducing the natural flow of oxygen and blood back to the heart, which causes fatigue and blood pooling in the lower extremities and can lead to lower back pain and leg pain.

### SUMMARY OF THE INVENTION

According to one exemplary embodiment, an interior modular floor mat assembly having anti-fatigue properties is provided. The modular floor mat assembly includes a top mat and a lower support frame. The lower support frame has a compressible body with a recessed cavity having a contoured border. The top mat nests within the recessed cavity.

According to another exemplary embodiment, a lower support frame of a modular floor mat assembly is presented. The lower support frame includes a body fabricated from a compressible polymer with a durometer measurement of less than approximately 60 Shore C. The support frame body has a recessed cavity that is circumscribed by a chamfered border. The cavity is designed to nest therein one of a plurality of interchangeable top mats to thereby form the modular floor mat assembly.

In accordance with yet another exemplary embodiment, a modular floor mat assembly is presented. The modular floor mat assembly includes a plurality of generally planar, flexible, elongated top mats. The interchangeable top mats all have substantially the same length and height. At least some of the interchangeable top mats each have a top face with distinct artwork thereon. The modular floor mat assembly includes a lower support frame with an elongated body that is fabricated from a compressible polymer with a durometer measurement of less than approximately 60 Shore C. The support frame body has a recessed cavity that is circumscribed by a round-chamfered border. One of the elongated top mats is removably attached to the support frame body at least partially within the recessed cavity.

The above summary of the invention is not intended to represent each embodiment, or every aspect, of the present invention. The above features and advantages, and other features and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is an elevated perspective-view illustration of a modular floor mat assembly in accordance with embodiments of the present invention;

FIG. 2 is an elevated perspective-view illustration of the modular floor mat assembly of FIG. 1 with the top mat partially removed from the support frame;

FIG. 3A is a plan-view illustration of the support frame of FIG. 1;

FIG. 3B is a sectional side-view illustration of the support frame of FIG. 1 taken along line A-A of FIG. 3A;

FIG. 3C is an enlarged side-view illustration of a corner of the support frame of FIG. 1; and

FIG. 4 is a sectional side-view illustration of an alternative support frame configuration with a variable-depth recessed cavity.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE EXEMPLARY EMBODIMENTS

While this invention is susceptible of embodiment in many different forms, there is shown in the drawings and will herein be described in detail representative embodiments of the invention with the understanding that the present disclosure is to be considered as an exemplification of the various aspects and principles of the invention, and is not intended to limit the broad aspect of the invention to the embodiments illustrated. To that extent, elements and limitations that are disclosed, for example, in the Abstract, Summary of the Invention, and Description of the Exemplary Embodiments sections, but not explicitly set forth in the claims, should not be incorporated into the claims, singly or collectively, by implication, inference or otherwise.

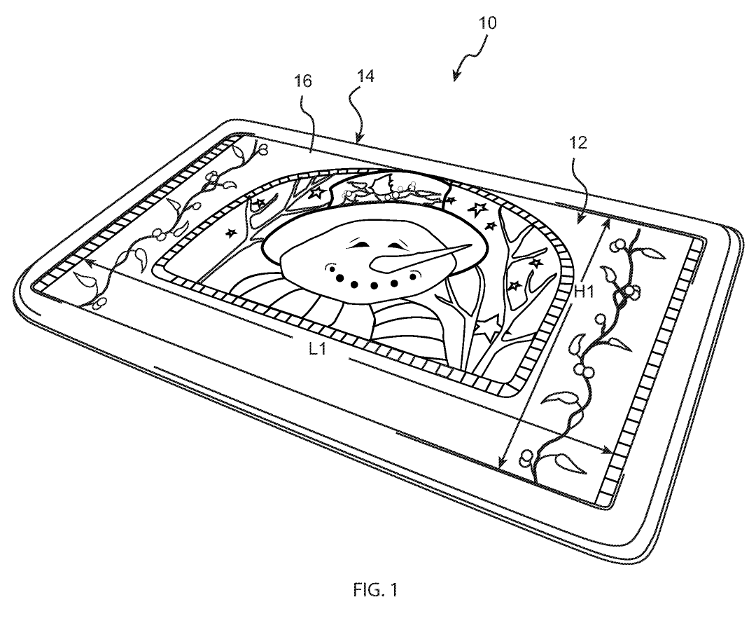

Referring to the drawings, wherein like reference numbers refer to like components throughout the several views, FIG. 1 illustrates a modular anti-fatigue floor mat assembly, indicated generally at 10, in accordance with one embodiment of the present invention. The particular floor mat arrangement shown in FIG. 1 is provided merely for explanatory purposes, and should therefore not be considered limiting. By way of example, and not limitation, the modular floor mat assembly 10 of FIG. 1 is intended for use as an anti-fatigue kitchen mat. However, the concepts of the present invention may just as readily be applied to other floor mat assemblies, such as, for example, bath mats, clean room mats, etc. In addition, the drawings presented herein are not to scale and are provided purely for instructional purposes. Thus, the individual and relative dimensions shown in the drawings are not to be considered limiting.

The modular anti-fatigue floor mat assembly 10 of FIG. 1 includes two primary components: a top mat 12 and a lower support frame 14. The top mat 12 shown is, in some embodiments, one of a plurality of flexible interchangeable top mats that can mate with and temporarily assemble to the lower support frame 14. In this instance, each top mat 12 is a generally planar, elongated sheet of crumb rubber with a printed logo, artwork, or other decor on an upper surface 16 thereof. The upper surface 16 may be made of a nonwoven polyester material that provides the artwork or decor. The logo, artwork, or decor may be selectively varied to provide the user with different themes, such as holiday themes (e.g., Christmas, Hanukkah, Halloween, Thanksgiving, etc.) or seasonal themes (e.g., Spring, Fall, Summer, Winter). In this regard, one advantage of a modular floor mat assembly, such as the modular anti-fatigue floor mat assembly 10 of FIG. 1, is the ability to change the appearance of the floor mat without having to replace the entire assembly. In addition, some aspects of the present concepts may require the top mat 12 be fabricated from a material that allows the anti-fatigue properties of the underlying lower support frame 14 to pass through the top mat 12.

Each interchangeable top mat 12 has substantially the same length L1, height H1, and thickness T1 (FIG. 2) to facilitate interchangeability. That is, according to certain aspects of the present concepts, the length L1, height H1, and thickness T1 of each top mat 12 is universal such that any one of the top mats 12 nests within a recessed cavity 20 of the lower support frame 14. Although illustrated as a rectangular, flat sheet, it should be recognized that the shape, material and dimensions of the top mat 12 can be varied depending, for example, on its intended application. For example, the top mat 12 may take on other optional shapes, such as square, elliptical, and circular silhouettes, and may vary in size and thickness. Likewise, the top mat 12 material may be varied, for example, to accommodate varying cost and design constraints.

According to some embodiments of the present invention, the lower support frame 14 is an ergonomic anti-fatigue mat with an elongated body that is fabricated, for example, from a compressible polymer. By way of non-limiting example, the support frame 14 is fabricated from polyvinyl chloride (PVC) foam, nitrile rubber, vinyl polymers, urethane, polyurethane, silicone, or silicone gel, or combinations thereof. In alternative configurations, the support frame body 14 may be fabricated from other anti-fatigue materials, such as gel-filled constructions, and may include added features such as static-discharge characteristics and anti-microbial surface treatments.

The durometer measurement of the material from which the support frame 14 is fabricated may be selected to provide the aforementioned anti-fatigue properties. Durometer measurements using the Shore C scale are often used in conjunction with measurements of resilient materials, such as foams, rubbers and elastomers. In some embodiments, the lower support frame 14 has a durometer (Shore C) measurement of less than approximately 60. In other embodiments, the lower support frame 14 has a durometer measurement of less than approximately 50 (Shore C). In one preferred embodiment, the lower support frame 14 has a durometer measurement in the range of approximately 30-45 (Shore C). As discussed below, in one specific embodiment, the lower support frame 14 is made of a PVC foam and has a durometer measurement of approximately 42-43 (Shore C).

In addition to characterizing the lower support frame 14, the anti-fatigue aspects of the overall assembly 10 can also be measured. For example, when an average-sized person is in a standing position, the amount of pressure at various parts of the foot will vary, but are often in the range from 5 psi to 10 psi. Thus, when a certain pressure is placed on the assembly 10 via the flexible top mat 12, the top mat 12 will deflect downwardly by a certain distance. The downward deflection is primarily due to the deflection in the lower support frame 14, although some deflection may be attributed to the flexible top mat 12 depending on its composition and construction. In one test using a lower support frame 14 made of PVC foam (thickness about 11 mm) and a top mat 12 made of crumb rubber (thickness about 5 mm), 10 lbs was placed over an area of 1 square inch to result in a pressure of approximately 10 psi. Under this condition, the upper surface of the top mat 12 deflected downwardly by approximately 5 mm. In summary, in response to a pressure of approximately 10 psi on the top mat 12 when assembled in the lower support frame 14 in the overall assembly 10, the top mat 12 deflects downwards by at least 3 mm, in some embodiments by at least 4 mm, and more specifically in one preferred embodiment by approximately at least 5 mm. Thus, the assembly 10 may exhibit a compressive deflection on the top mat 12 in the range for approximately 0.3 mm/psi to 0.5 mm/psi, when the applied pressure is in the range of 5 to 10 psi.

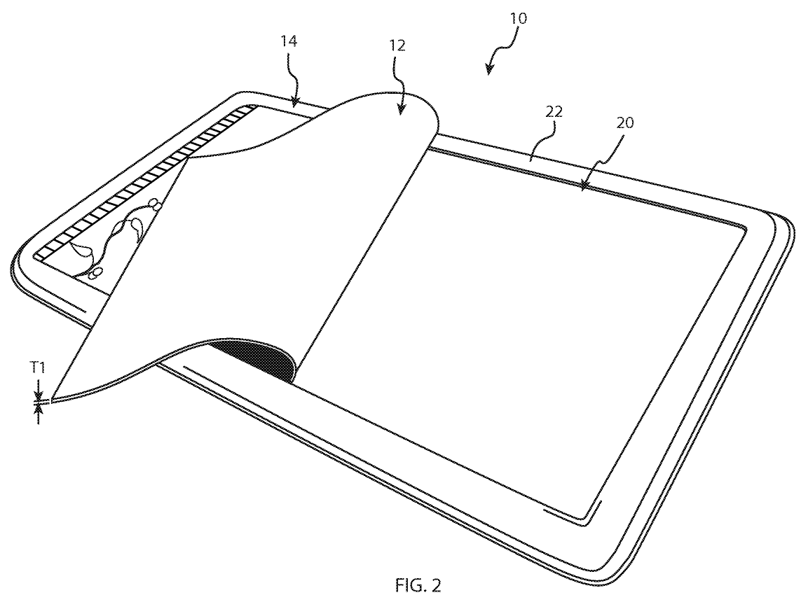

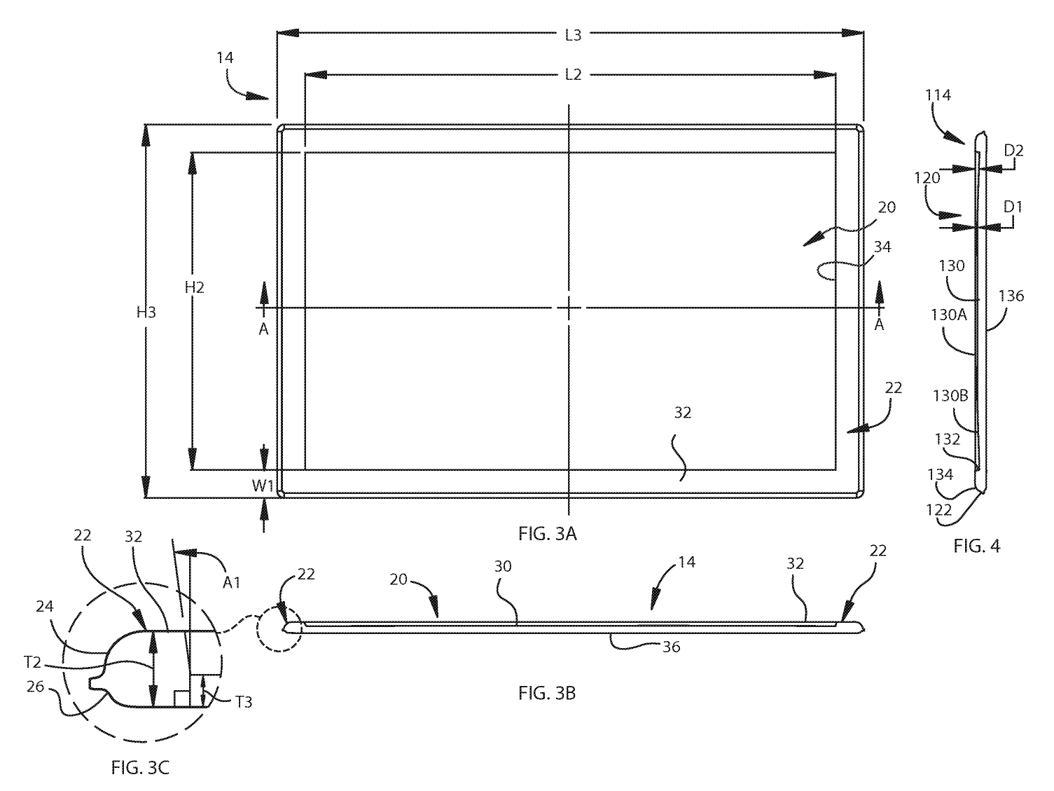

Referring to FIG. 3A, the support frame body 14 defines a recessed cavity 20 that is surrounded or circumscribed by a contoured border 22. In the illustrated embodiment, the lower support frame 14 and the recessed cavity 20 are both rectangular, although the shapes of the lower support frame 14 and the recessed cavity 20 can be individually or collectively modified without departing from the intended scope of the present invention. The length L2 and height H2 (FIG. 3A) of the recessed cavity 20 are approximately equal to the length L1 an height H1 (FIG. 1), respectively, of the top mat 12 such that any one of the interchangeable top mats 12 nests or rests generally coterminously with or within the recessed cavity 20. Similar to the top mat 12, the overall length L3 and height H3 of the lower support frame 14, as well as the shape and material, can be varied, for example, to accommodate varying cost and design constraints. Likewise, the width W1 of the contoured border 22 can be selectively varied depending, for example, on the intended use of the modular floor mat assembly 10.

In some embodiments, the contoured border 22 has round-chamfered upper and lower, outer corners 24 and 26, respectively, as best seen in FIG. 3C. Both round-chamfered corners 24, 26 illustrated in FIG. 3C may extend continuously around the outer periphery of the lower support frame 14. The upper rounded corner 24 is curved in a manner such that it is less likely that a person will catch their foot on the mat when they are walking across the floor mat assembly 10. A flange 28 projects outwardly from the contoured border 22. As seen in FIG. 3C, the flange separates the upper and lower corners 24, 26, and may be arranged to extend continuously around the outer periphery of the lower support frame 14. In an alternative embodiment, the contoured border 22 has no (or a slight) lower corner 26 and the upper rounded corner 24 extends to the bottom surface 36 with no intermediate flange 28. In a further embodiment, the contoured border 22 gradually slopes on a planar or nearly planar profile to the bottom surface 36. The flange 28 may result from the fabrication (i.e., shaping) of the rounded corners 24, 26. For example, if the lower support frame 14 is fabricated from one or more polyhedral pieces of PVC foam, the outer square corners thereof may be drawn together—i.e., the upper corner of the outer peripheral edge drawn downward and the lower corner upward. These corners are then connected together (e.g., via heat forming), the flange 28 being the point at which the two corners meet and are attached.

With continuing reference to FIGS. 3A and 3B, the recessed cavity 20 includes a base 30 that is recessed downwardly from an upper surface 32 of the support frame body 14. In this particular instance, the upper surface 32 is the highest plane of the contoured border 22. A wall 34 extends upwardly from and generally continuously around the outer perimeter of the recessed base 30. The contoured border 22 of the lower support frame 14 therefore has a thickness T2 that is greater than the thickness T3 of the recessed cavity 20 portion of the lower support frame 14. In another embodiment, when the material is PVC foam, the thickness T3 of the recessed cavity 20 is in the range of approximately 8 mm to 15 mm thick. For example, the thickness T3 of the recessed cavity 20 is approximately 11 mm and the thickness T2 of the contoured border 22 is approximately 16 mm. In such an embodiment, the depth of the recess is approximately 5 mm and the thickness of the top mat 12 is also approximately 5 mm to make it substantially coplanar with the border 22. In this example, the depth of the recessed cavity 20 is approximately equal to the thickness of the top mat 12. In some embodiments, for example, the depth of the recessed cavity 20 and the thickness of the top mat 12 are approximately equal to 3-6 mm. In some embodiments, the wall 34 extends at an angle A1 of over 90 degrees relative to the bottom surface 36 of the support frame body 14, as seen in FIG. 3C. For example, the angle A1 may be 100 degrees. If fabricated from PVC foam, the lower support frame 14 may exhibit a durometer measurement of approximately 42-43 (Shore C).

The recessed cavity 20 may be fabricated, for example, in two different ways. In a first instance, a single, solid panel of PVC foam may be cut to size. A central region of the PVC foam panel is thereafter heat embossed to produce the cavity 20. In an alternative example, two separate pieces of PVC foam are welded (e.g., high-frequency electric welding) together along their outer peripheries. A central region of the two-panel construction is thereafter heat embossed to produce the cavity 20. The heat-embossing process may also act to compress and weld the upper of the two PVC panels down into the lower of the two PVC panels. The edges of the two panels are welded along the flange 28.

FIG. 4 presents a lower support frame 114 with a variable-depth cavity 120. According to this alternative embodiment, the base 130 of the recessed cavity 120 has a variable depth relative to the upper surface 132 of the support frame 114. By way of non-limiting example, the base 130 has a central region 130A that is generally parallel to a bottom surface 136 of the support frame body 114. An outer, ramped region 130B circumscribes the central region 130A. As seen in FIG. 4, the outer region 130B slopes downward from the central region 130A, which has a first depth D1, to the wall 134, which has a second depth D2 that is larger than the first depth D1. The grade of inclination can be varied or outright eliminated from that which is shown in the Figures.

The thicker center portion of the frame 114 in FIG. 4 provides more anti-fatigue properties in the middle of the frame 114, which is the location at which the user is more likely to stand.

It may be desirable that the top mat 12 be removably attached to the lower support frame 14. To assemble the modular floor mat assembly 10, the top mat 12 is placed (i.e., laid flat) within the recessed cavity 20 of the lower support frame 14. Preferably, the top mat 12 lies flush with the upper surface 32 of the lower support frame 14. As described above, the coinciding lengths L1, L2 and heights H1, H2 of the top mat 12 and support frame cavity 20, respectively, allow the top mat 12 to nest generally coterminously within the recessed cavity 20. The top mats 12 are temporarily retained within the support frame body 14 via friction engagement with the outer wall 34 of the recessed cavity 20.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. An interior modular floor mat assembly having anti-fatigue properties comprising:
a top mat; and
a lower support frame having a compressible body defining a recessed cavity with a contoured border, the top mat nesting within the recessed cavity.

2. The modular floor mat assembly of claim 1, wherein the lower support frame has a durometer measurement of approximately 30-45 Shore C.

3. The modular floor mat assembly of claim 1, wherein, in response to a pressure of approximately 10 psi on the top mat, the top mat deflects downwards by at least approximately 3 mm.

4. The modular floor mat assembly of claim 1, wherein the contoured border has a round-chamfered upper corner.

5. The modular floor mat assembly of claim 4, wherein the contoured border has a flange extending outwardly therefrom.

6. The modular floor mat assembly of claim 1, wherein the support frame body is fabricated from at least one of PVC foam, nitrile rubber, vinyl, urethane, silicone, and silicone gel.

7. The modular floor mat assembly of claim 1, wherein the recessed cavity includes a base recessed from an upper surface of the support frame body, and a wall extending upwardly from the recessed base.

8. The modular floor mat assembly of claim 1, wherein the recessed cavity has a depth that is approximately equal to a thickness of the top mat.

9. The modular floor mat assembly of claim 1, wherein the lower support frame is PVC foam having a thickness in the recessed cavity of approximately 8 mm to 15 mm.

10. The modular floor mat assembly of claim 1, further including a plurality of interchangeable, flexible top mats, the top mat being one of the plurality of interchangeable top mats, each of the plurality of interchangeable, flexible top mats being configured to be releasably received within the support frame body.

11. The modular floor mat assembly of claim 10, wherein at least some of the plurality of interchangeable top mats have a top face with different artwork thereon.

12. A lower support frame of a modular floor mat assembly, the lower support frame comprising:
a body fabricated from a compressible polymer with a durometer measurement of less than approximately 60 Shore C, the body defining a recessed cavity circumscribed by a chamfered border, the cavity being configured to nest therein one of a plurality of interchangeable top mats to thereby form the modular floor mat assembly.

13. The lower support frame of claim 12, wherein the support frame body has a durometer measurement of approximately 30-45 Shore C.

14. The lower support frame of claim 12, wherein the recessed cavity of the support frame body includes a base recessed from an upper surface of the support frame body, and a wall extending upwardly from and generally continuously around the outer perimeter of the recessed base.

15. The lower support frame of claim 12, wherein the border has at least one round-chamfered corner.

16. The lower support frame of claim 12, in combination with the plurality of interchangeable top mats, each of the top mats being removably mounted within the recessed cavity.

17. The lower support frame of claim 16, wherein the recessed cavity has a depth that is approximately equal to a thickness of the top mats, wherein the depth of the recessed cavity and the thickness of the top mats are approximately in the range of 3-6 mm.

18. The lower support frame of claim 12, wherein the support frame body is PVC foam having a thickness in the recessed cavity of approximately 8 mm to 15 mm.

19. A modular interior floor mat assembly having anti-fatigue properties, comprising:
a plurality of generally planar, flexible top mats, each of the top mats having substantially the same length and height, at least some of the plurality of top mats each having a top face with different artwork thereon; and
a lower support frame having an elongated body fabricated from a compressible polymer with a durometer measurement of less than approximately 60 Shore C to provide the anti-fatigue properties to the user, the support frame body defining a recessed cavity circumscribed by a border, each of the plurality of top mats interchangeably fitting within the recessed cavity of the support frame body.

20. The modular interior floor mat assembly of claim 19, wherein the lower support frame is made of PVC foam having a thickness in the recessed cavity of between 8 mm and 15 mm, a depth of the recessed cavity and each of the plurality of top mats having substantially the same dimension such that a top face of a top mat mounted within support frame is substantially coplanar with an upper surface of the support frame along the border.
